(19) United States
(12) Patent Application Publication
(10) Pub. No.: US 2002/0095281 A1
(43) Pub. Date: Jul. 18, 2002

(54) Electronic text communication system

(75) Inventors: Gregg M. Cox, Osterholz-Scharmbeck (DE); Hans L. Grafelmann, Bremen (DE)

Correspondence Address: WOOD, HERRON & EVANS, L.L.P., 2700 Carew Tower, 441 Vine Street, Cincinnati, OH, 45202, US

(73) Assignee: Global Language Communication System, e.K.

(21) Appl. No.: 09/963,823

(22) Filed: Sep. 26, 2001

(30) Foreign Application Priority Data
Sep. 28, 2000 (DE) 100 48 069.1-53

(51) Int. Cl. G06F 17/28

(52) U.S. Cl. 704/2

(57) ABSTRACT

An electronic data transmission device includes an electronic text recording device which records a text which is written or spoken in a first language and transforms the text into electronic data. An electronic data translation device is coupled with a text recording device and includes a data processing system and a translation program having a data bank with saved grammatical and vocabulary information. The data processing system translates the electronic data by way of the data processing system, and according to the grammatical and vocabulary information, into second electronic data which represents the recorded text in the second language. An electronic text reproduction device is coupled with the data translation device and reproduces the second electronic data as written and/or spoken text.

The present invention concerns an electronic text communication system.

Mankind uses language for communication. In the present globalization of the communication of human society it has become more and more significant to use a foreign language. This concerns the written as well as the spoken language, as communication takes place in different ways and through different channels in which both possibilities are playing a part. The ability to speak a language is necessary both passive as well as active, because it is not sufficient to understand the conversation partner, but we would like to be able to reply in his language.

Known to us are translation programs for computers which allow the user to translate a text from one language into another. Here the program determines from which and into which language the translation takes place, and accordingly the program usually functions in one of these two languages. For this purpose the text which is to be translated has to be on hand in a data format compatible for the computer and has to be entered into the computer. Also the release is made in a text format usual for a computer.

In comparison to the above-mentioned requirements for translation of tests from one language into another the quite limited application possibilities of known translation programs is obvious and can be explained by a simple but extreme example: a Japanese and an American business partner have no knowledge of the language of the other, and they wish to communicate without an interpreter, for instance at a mutual evening dinner. There is a way of using the translation program from a notebook if they would be able to type quickly, However, if the other partner wants to reply to the text he has read in the notebook, there is the obstacle of lacking knowledge of the typeface/characters which is used for the keyboard.

This invention is based on the task to create an electronic text translation device as well as an electronic text communication procedure which enables a quick uncomplicated translation of text from one language to another.

This function is solved with the invention by a device with the features described in claim No. 1 and by a procedure with the features described in claim 9. The preferred scope of the invention is mentioned in the sub-claims.

According to the invention, an electronic text translation device has an electronic text recording device, an electronic data translation device and an electronic text release device. The receiver device enters the text which is written or spoken in a first language and transmits it by transforming into an initial electronic data file. This can take place preferably with or in real time without intermediate saving of the data.

This has an advantage over the state of technique especially by the fact that with the invention device the translation of language can be performed extremely flexibly with just one specific device, either if written or spoken and recorded in a written and/or spoken reproduction of the second preferably selectable idiom.

Suitable recording devices for the recording of a spoken language is a microphone and for written language a typescript scanner with a program of type recognition which is secured in a processor or a data saver and which transforms the scanned typeface into electronic data by means of a processor. But also a keyboard or a data transmission interface are recording devices according to the invention, and the invention-based transmission device can have any combination of recording devices in order to prepare recording possibilities which conform to the different user requirements.

Also the reproduction device which preferably has a loudspeaker for the spoken reproducing of the translated text and a screen for the written reproduction of the translated text as well as a data transmission interface in order to transmit the translated text for instance to a printer or a data saver, can inventively have any combination of reproduction devices according to the different user requirements.

The translation device is in data transmission connection with the recording device in order to take over the recorded first electronic data from there, and with the reproduction device in order to transmit the second electronic translated data which represent the translated text for reproduction. This translation device has a data processing device and a translation program which is saved within the processor or a data securing device. In a data bank which is also saved in the translation device there is information about grammar and vocabulary at least on one language from which is to be translated and on a second language into which is to be translated. By means of the processor and the translation program the translation device translates the recorded text according to this grammar and vocabulary information which are designated here in short as “language rules”, in a way that the translation device translates the first electronic data from the text recording device according to the language rules into the second electronic data

As preferred special feature the data bank of the translation program has language rules of more than two languages so that the inventional text transmission device enables favorably the translation between several languages which can preferredly selected. For selection of the languages the transmission device has preferably a language selection device in which the languages can preferredly selected from a catalog of available languages. The languages can be in the same language and the pertaining typeface as well as additionally in another typesetting and language which has been selected for translation. Also a stipulation of the languages by means of unmistakable code numbers is possible according to the invention. As “language” is also a distinction structure in dialects possible—for instance high German, Bavarian and Plattdeutsch (Low German) or British and US-American English.

The invention-based procedure for automatic transmission of a text from an initial into a second language is preferably possible by means of the inventional device and, therefore, in this invention-based procedure also, according to the afore-mentioned, a written or spoken text in an initial language is first recorded and transformed into electronic data. The next following step of the translation is according to the invention consisting of several individual steps and is performed by application of tables in which information on the first and the second language is contained. Preferably the step is preceded by selecting the two languages taking part in the translation from multiple tables and to prepare the available tables accordingly.

These tables contain according to the invention in the first place the name of the language perferably (as described above) as code number as well as a designation in the language as well as preferably also in all other available languages (preferably assigned to the corresponding language name code number for easier recognition). Furthermore the tables contain the words of the language which have assigned recognizable indication codes, preferably numbers, whereby the words with same meaning receive the same indication codes in the different tables of the different languages. Hereby multiple mentioning of words with several different meanings are according to the invention which have each another indication code assigned.

In the translation step of the invention-based procedure the electronic data which represent the text recorded in the first language the data are separated according to the first table with the information on the first language into words, and for each word the indication code assigned from the table. In the table of the second language the corresponding word is determined by the indication code from the table and then placed in one line electronically according to the sequence and the order of sentences of the words in the recorded text of the first language. In a next following step the translation is now adjusted according to the invention by adjusting each aligned word of the second language in ist grammar form to the other of the aligned words of the same sentence in such a ways that for each language at least another table applies in which the grammar connections of the language are contained. The sentences which were corrected in such a way and which are now available as second electronic data, are then reproduced electronically according to the invention by transformation into written and/or spoken text.

Especially for the reproduction as spoken text a sound signal is assigned to each word in the tables which represents the pronunciation of the word in the corresponding language.

For many languages certain grammar forms of their words are depending on whether the speaker is male or female. If for example a person wants to say in Spanish that he is tired, he says “soy cansado”. If this person is female, however, she says “soy cansada”. A false application of these forms can be very ridiculous and embarrassing for the speaker. The same applies for so-called courtesy or formal forms. In German the use of the second person (“Du”) as personal address and the third person (“Sie”) as formal addressing is evident. The Japanese language contains a larger number of grades of courtesy which effect especially the endings of verbs. Since these grammatical dependencies, i.e. from the sex of the author as well as from the grade of courtesy and formality of the author towards a recipient cannot be safely determined from the context of the language from which is being translated (but only if also this language makes these distinctions), the invention-based transmission device has preferably recording features which distinguish between the sex of the author and/or the grade of courtesy and/or formality between author and recipient. In order to make these recording devices understandable in any language, the selection positions of the recording devices are marked preferably by generally understandable pictograms. Also all further user elements of the device are preferablymarked with pictograms like for example keys for selecting the reproduction of the translated text, spoken or written. The invention-based procedure considers the selection of the sex of the author and the grade of courtesy or formality preferably, in such a way that corresponding differentiaited tables are opened which for example assign for the German word “tired” at first through the corresponding indication code the male or the female form of the Spanish word, in order to then branch out according to the entered sex of the author to the correct form “cansado” or “cansada”.

As special advantage of the of the invention-based device is the possibility of translation from languages in a large number of combinations of the idioms.

The device is preferably designed in such a way that the user can easily handle it without having to understand a certain user guiding language. The user can speak the text which is to be translated or can prepare it in writing, and the reproduction of the translation can be performed in spoken and/or written version. Here a separation of the invention-based text transmission device is perferably possible in two device units according to the invention, of which the first records only spoken text and reproduces it and the second only written text. Since in this way the first device unit can dispense with the complex recording and reproducing devices for written text, like preferably scanner and monitor, and for spoken text requires only a microphone and loudspeaker, the first device unit for spoken text can be extremely compact. This is especially advantageous because in a conversation which does not necessarily have to take place at a certain location where the text transmission device can be placed on a table for example, the small and light design of the device is less disturbing and therefore very favorable.

The two device units can be combined preferably so that after combination through cooperating connection, media signal transmission are produced between the device units which enable a written reproduction of the translation of a spoken text and a spoken reproduction of the translation of a written text according to the invention.

The invention is described in the following with reference to the attached drawings.

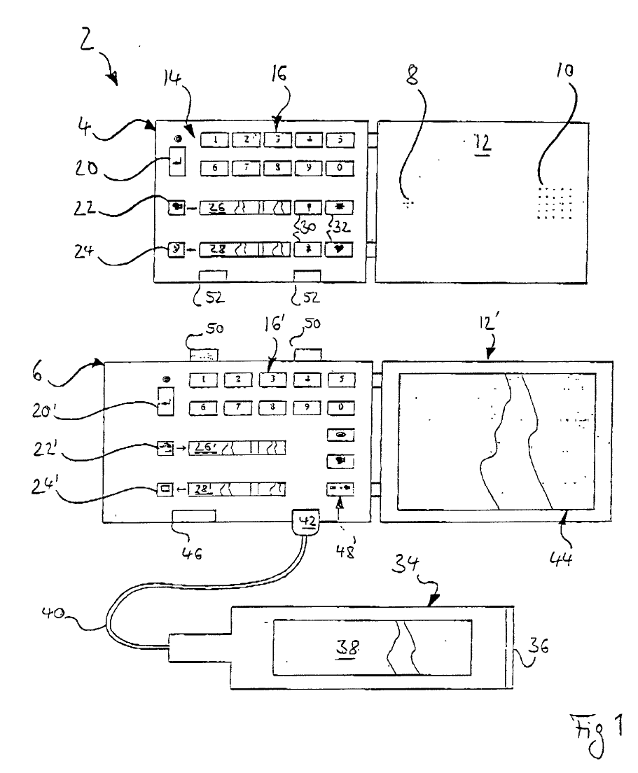

FIG. 1 shows a diagram of the invention-based text transmission device

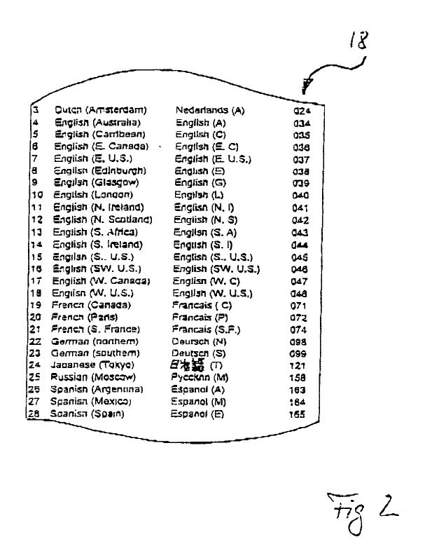

FIG. 2 shows a table in which code numbers for language names are assigned invention-based

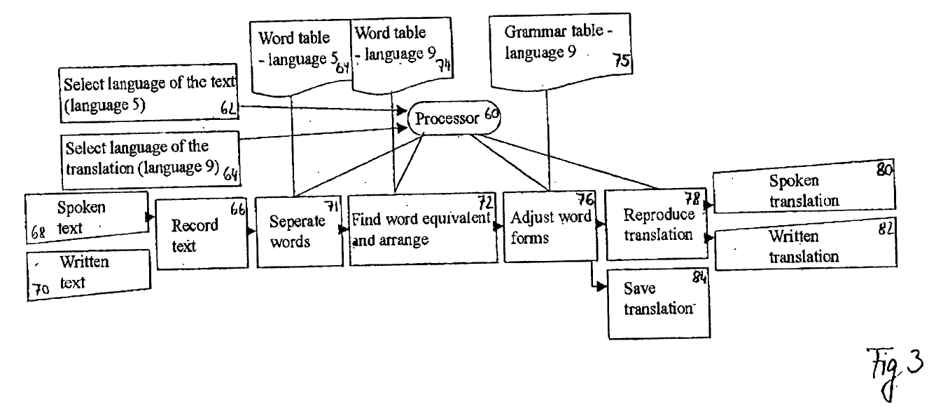

FIG. 3 shows a flow diagram of a process of text transmission according to the invention.

In FIG. 1 the text transmission device 2 is illustrated. It contains a first device unit 4 and a second device unit 6. The first device unit 4 serves for translation of a spoken text from a first into a second language. The spoken text is recorded by a microphone 8 of the device unit 4, and the translation is reproduced by means of a loudspeaker 10 of the device unit 4.

The microphone 8 and the loudspeaker 10 are located on the inner side of the lid 12 which is illustrated in FIG. 1 in opened position and which can be placed and closed over the keyboard 14 for protection of the keyboard 14 of the first device unit.

The keyboard 14 shows a language selection device which contains a number keyboard 16 for recording of a language indication code number 18 according to a table which is illustrated in FIG. 2, as well as a keyboard 20 for confirmation of entering the code number 18.

Furthermore the language selection device of a recording language selection key 22 for signalizing that the recorded language indication code 18 of the language which is recorded by means of the microphone 8 and is to be translated, as well as a reproduction language selection key 24 for signalizing that another entered language indication code number designates the language in which is to be translated and which then by means of a microphone 10 is reproduced. A first indication window 26 shows accordingly the name of the first language and the assigned indication code and a second window 28 the name of the second language with assigned indication code.

With a first pair of keys 30 at which one key is marked with a male and a second key is marked with a female symbol, the selection of the key can determine if for the first language (in this case the entering key for language selection 22 is first or additionally or subsequently pressed) or if for the second language (then the language selection key 24 is first, in addition or subsequently pressed) the speaker is male or female. With a second pair of keys 32 for which a key is marked with a heart symbol as pictogram for “hearty” or “personal” and the second key with a star symbol for “formal”, the grade of courtesy and/or formality between speaker and recipient is determined according to the first and the second language.

The second device unit 6 serves to translate from a written text which is recorded by means of a scanner 34. The scanner 34 has a reader head 36 for scanning the text to be recorded as well as a display 38 for displaying the recorded text and is connected with the housing of the second device unit 6 by a cord 40 and a plug 42.

The second device unit 6 shows a screen 44 for reproducing the translation as written text. Furthermore, a printer interface 46 serves as reproducing device of the translated text. The screen 44 is situated in a cover 12′ which can be closed over a keyboard 16′ of the second device unit 6 just like the cover 12 of the first device unit 2. The keyboard 16′ of the second device unit 6 is in principle constructed like the keyboard 16 of the first device unit 2. For improved review, the first pair of keys 30 for selection of the gender of the speaker and the second pair of keys 32 for selection of the grade of courtesy are not marked on the second device unit 6. There are an additional three keys 48 for selection of the means of reproduction of the translation, One of the three keys 48 is marked with an eye for selection of written reproduction of the translation on the screen 44 exclusively, a second of the three keys 48 is marked with a speaking head for selection of spoken reproduction of the translation with a loudspeaker (not visible) on the backside of the cover 12′, and the third of the three keys 48 is marked with the two symbols for seldction of the written as well as the spoken reproduction of the translation.

The first device unit 2 and the second device unit 6 show each a connection medium such as co-functioning plugs 50 and sockets 52. Furthermore, cord connections can be made between the device units 2 and 6 for functional links of both devices 2 and 6.

FIG. 3 shows as flow diagram an invention-based process for automatic transmission of a text from one first language into a second. At first an information is given (62) to a data processing device 60 from which language the processor should translate a following text (in the present example a language with the code number 5) and subsequently (64) into which language the translation is to be made (here for example language No. 9). Subsequently a text to be translated is recorded (66), such as in the present example a spoken text 68, although also a written text 70 could be recorded.

On the basis of the determination 62 of the language from which the text is to be translated, the processor 60 prepares a table with information on these languages of the context of the secured available different tables on the different languages the translation of which the process in capable and now separates (71) according to the words which are found in table 69 the recorded text into individual words. Table 69 contains the words of the language in which the text was recorded as well as additionally an indication code which is assigned to each meaning of a word of the language.

According to the indication code, the processor 60 now ascertains (72) the words of the second language corresponding to their meaning from a second table 74 which the processor has prepared according to the primary designation 64 of the language into which is to be translated. These words of the second language which correspond in their meaning are arranged by the processor 60 by sentences according to the sequence of the words in the recorded text 68.

The word forms in the second language arranged in this way are structured grammatically according to a grammar table 75 on the second language which the processor 60 has received, grammatically arranged, according to the initial information 64 on the language into which the translation is to be performed.

The sentence built from this information is now edited (78) in genuine time, which means that the translation of a sentence is reproduced in spoken language (80) as soon as the grammatical adjustment 76 of the word forms have been assembled to build a sentence. At the same time the translation is also reproduced in writing (82), for example on a screen 44 (FIG. 1), and the translation is saved (84).

Since the invention-based process according to FIG. 3 is an electronic data processing system, the “words” in the steps 70, 72 and 76 and in the tables 69, 74 and 75 are electronic data which represent the words of the corresponding language. Accordingly, the recording 66 of the text also comprises of the transformation of the text into electronic data, and the reproduction 78 of the translation comprises also the re-transforming of the electronic data for example into loudspeaker signals for acoustic reproduction 80

1. Electronic data transmission device (2) with
an electronic text recording device (8, 34) which records a text (68, 70) which is written or spoken in a first language, and transforms into electronic data,
an electronic data translation device which is in data transmission connection (40) with a text recording device (34) and which comprises a data processing system (60) and a translation program saved in the processor (60) or a data saving system with a data bank (69, 74, 75) with saved grammatical and vocabulary information (language rules) on the first and a second language and translates the electronic data by means of the processor (60) according to the language rules (69, 74, 75) into second electronic data which represent the recorded text in the second language, and with an electronic text reproduction device (10, 44) which is in data transmission connection with the data translation device and which reproduces the second electronic data as written and/or spoken text (80, 82).

2. Text transmission device according to claim 1, wherein the electronic recording device has a script scanner (34) and a processor and a script recognition program saved in the processor or a data saver and/or a microphone (8) and/or a keyboard (16) and/or data entering interface (52).

3. Text transmission device according to one of the preceding claims wherein the electronic reproduction device contains a loudspeaker (10) and/or a screen (44) and/or a printer and/or a data exit interface (46).

4. Text transmission device according to one of the preceding claims wherein the data bank (69, 74, 75) of the translation program comprises language rules of more than a second language and the translation device contains a language selection device (16-28) for selection of the second language.

5. Text transmission device according to one of the preceding claims wherein the language rules (69, 74, 75) contain interdependence of the gender of an author of the language and the translation device contains a recording device (30) for entering the gender of the author and the translation device takes reference to these interdependence at translation from the first and/or into the second language.

6. Text transmission device according to one of the preceding claims wherein the language rules (69, 74, 75) contain interdependences from the grade of courtesy and/or formaility of the author towards a recipient and that the translation device contains a recording device (32) for entering the grade of courtesy and/or formality and the translation device refers to these dependences at translation from the first and/or into the second language.

7. Text transmission device according to claim 6, wherein the grade is selectable between “personal” and “formal”.

8. Text transmission device according to one of the preceding claims wherein
a first device unit (2) contains a first electronic text recording device (8) for the spoken language, a first electronic translation device and a first electronic reproduction device (10) for the spoken reproduction
a second device unit (6) contains a second text recording device (34) for the written language, a second electronic translation device and a second electronic reproduction device (44) for the written reproduction and
the first device unit (4) and the second device unit (6) contain co-functioning connection media (50, 52) for signal connections for written reproduction of the translation recorded from the first device unit of spoken text by means of the second device unit and/or the spoken reproduction of the written translation recorded by the second device unit by means of the first device unit.

9. Process for electronic transmission of a text (68, 70) from a first language into a second with the steps:
electronic recording of a text spoken or written in a first language (68, 70) als electronic data,
program guided electronic separation (71) of data in worts of the text according to a first table (69) in which the words of the first language are contained,
program guided electronic determination of an indication code of each word of the text (68, 70) according to the first table in which the indication code is assigned in addition to each word of the first language
for each of the words of the text (68, 70) a program guided electronic determination (72) of a word of same meaning of the second language according to a second table (74) in which the same indication code is assigned to each word of the second language with the same meaning
a program guided electronic assignment (72) of the ascertained word of the second language according to the sequence and sentence structure of the words in the first text (68, 70)
a program guided electronic adjustment (76) of the grammatical form of each of the assigned words to the remaining of the assigned words of the same sentence according to at least one table (75) in which the grammatical coherences of the second language are contained
an electronic reproduction (78) of electronic data which represent the sentence formed from the assembled words in the second language as written or spoken text (80, 82).

10. Process according to claim 9, wherein the steps (66, 71, 72, 76, 78) are performed in reality time without interim saving of the data.

11. Process according to claim 9 or 10, wherein the first table (69) and/or the second table (74) contain a sound signal assigned to each word which represents the usual pronunciation of the word of the corresponding language and the sound signal is applied for reproduction (78) of the spoken text.

12. Process according to one of the claims 9 to 11 wherein the use of the device (2) according to one of the claims 1 to 8 applies.
